(19) United States
(12) Patent Application Publication
(10) Pub. No.: US 2016/0221374 A1
(43) Pub. Date: Aug. 4, 2016

(54) METHOD FOR TRANSFER PRINTING HARDWARE TOOL

(71) Applicant: SHANGHAI EASY-USE TOOLS ENTERPRISE CO. LTD., Shanghai (CN)

(72) Inventor: Shiyu SUN, Shanghai (CN)

(21) Appl. No.: 14/958,272

(22) Filed: Dec. 3, 2015

(30) Foreign Application Priority Data
Feb. 2, 2015 (CN) 201510053702.0

(51) Int. Cl. B41M 3/12

(52) U.S. Cl. CPC B41M 3/12

(57) ABSTRACT

A method for transfer printing hardware tool includes: selecting a transfer printing film according to a pattern to be printed on the hardware tool and activating the transfer printing film; covering an area on the hardware tool out of the pattern using a tubular mask, placing the hardware tool together with the tubular mask into water, and using the activated transfer printing film to perform transfer printing; and removing the hardware tool and the tubular mask from the water, baking or air-drying the hardware tool and the tubular mask, and removing the tubular mask from the hardware tool. The method for transfer printing uses the tubular mask to make a patterned area and a non-patterned area on the hardware tool in a single transfer printing process. The tubular mask is reusable and prevents sticky surface of the hardware tool, making its use convenient and economical.

### BACKGROUND OF THE INVENTION

1. Technical Field

The present invention relates to a method for transfer printing a hardware tool.

2. Description of Related Art

Water transfer printing is the latest digital image technology surpassing all previous printing methods. It uses special carriers made of nano materials and eco ink to print images on any solid media. It advantages includes no special to equipment required, no limitation on media, no special consumables requires and no high-temperature heating required. Anyone who has an image inputting device (such as a scanner or a digital camera), a graphic making device (such as a computer), and an image outputting device (such as an inkjet printer), plus ink and paper for water transfer printing can freely decorate a solid object having either flat or curve surface with various patterns that is colorful and has absolute photo-grade quality. In brief, the technology in use requires low investment and low operational threshold, and is suitable for nearly all applications.

For simultaneously making a patterned area and a non-patterned area on the same hardware tool through water transfer printing, normal manufacturers adopt a means that waterproof tape or sticky film is adhered to the hardware tool at where the non-patterned area is located and after water transfer printing the tape or film is removed. However, it is common that such tape or film leaves adhesive on the surface of the hardware tool. Such sticky surface degrades the cleanness and smoothness of the hardware tool and is undesired. Further, as such tape and film is relatively thin, the operation is difficult and inaccuracy tends to happen, making the resultant pattern incorrect. Also, such tape and film is typically not reusable, making the processing cost increase.

### SUMMARY OF THE INVENTION

In view of the problems of the prior art, the present invention provides a method for transfer printing hardware tool to effectively address the technical challenges seen in the prior art.

The present invention implements the following technical schemes to solve the foregoing problems:

A method for transfer printing hardware tool comprises the following steps: Step 1, selecting a transfer printing film according to a pattern to be printed on a hardware tool, and activating the transfer printing film; Step 2, covering an area on the hardware tool out of the pattern using a tubular mask, placing the hardware tool together with the tubular mask into water, and using the activated transfer printing film to perform transfer printing; and Step 3, removing the hardware tool and the tubular mask from the water, baking or air-drying the hardware tool and the tubular mask to dry, and removing the tubular mask from the hardware tool.

The tubular mask is made of a waterproof material.

The tubular mask includes an accommodating space for accommodating the hardware tool, in which the accommodating space has its periphery for contacting the hardware tool provided with a contacting surface.

The contacting surface and the hardware tool contact each other in a watertight manner.

The method for transfer printing uses the tubular mask to make a patterned area and a non-patterned area on the hardware tool in a single transfer printing process. The tubular mask is reusable and prevents sticky surface of the hardware tool, making its use convenient and economical

### BRIEF DESCRIPTION OF THE DRAWINGS

FIG. 1 shows a tubular mask according to one embodiment of the present invention;

FIG. 2 is an applied view of the tubular mask of FIG. 1; and

FIG. 3 shows a hardware tool has a pattern transfer printed thereon.

### DETAILED DESCRIPTION OF THE INVENTION

The invention as well as a preferred mode of use, further objectives and advantages thereof will be best understood by reference to the following detailed description of illustrative embodiments when read in conjunction with the accompanying drawings.

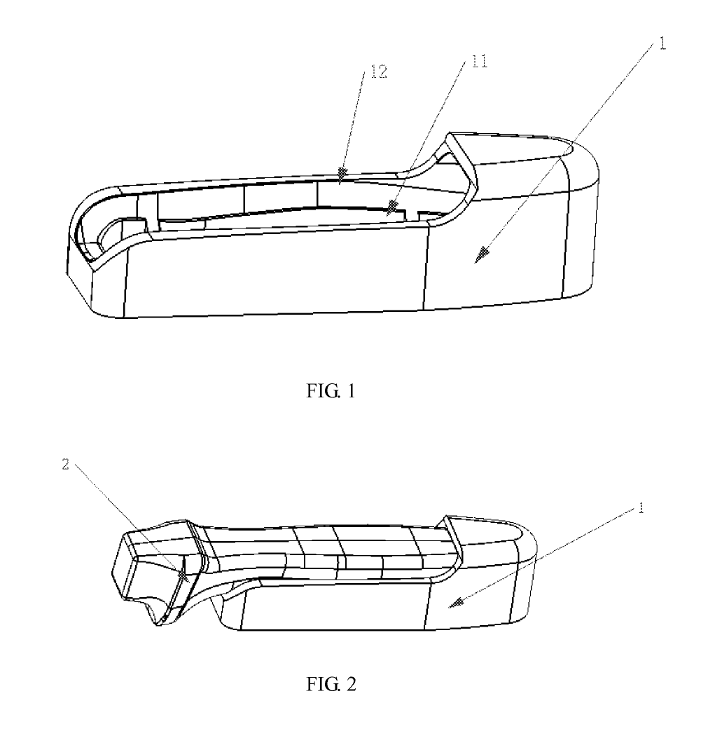

Referring to FIG. 1 through FIG. 3, the present invention discloses a method for transfer printing a hardware tool as described below.

In Step 1, a transfer printing film that has a pattern to be printed on the hardware tool is selected and activated in water.

In this step, the pattern to be printed on the hardware tool is determined according to the tool's design. Then a tubular mask 1 is made according to the pattern 3, so that the tubular mask can rightly cover an area 4 on the hardware tool 2 outside the pattern. The tubular mask is made of a waterproof material. When covering the hardware tool at where is intended to be a non-patterned area after the transfer printing process, the tubular mask insulates the non-patterned area from water. This ensures the non-patterned area not to be unintentionally printed. The pattern to be later transfer printed onto the hardware tool is then printed onto the transfer printing film.

Of course, if there is any available off-the-shelf transfer printing film suitable for the intended use, such off-the-shelf transfer printing film may be used.

For activation, the transfer printing film is placed into a container containing water and fully unfolded, and has the pattern printed thereon activated into a printing-ink state.

In Step 2, an area 4 on the hardware tool out of the pattern is covered by a tubular mask 1, and the hardware tool together with the tubular mask is placed into the water so that the activated transfer printing film can perform transfer printing.

In this step, water is a carrier that allows the activated pattern to be transferred onto the hardware tool. For water transfer printing, the hardware tool has the area 4 outside the designed pattern protected by the tubular mask 1, and is placed into the water in the container together with the tubular mask.

In Step 3, the hardware tool together with the tubular mask is removed from the water and baked or air-dried to dry. Then the tubular mask is removed from the hardware tool. When the tubular mask is removed, the area previously covered by the tubular mask remains free of the pattern.

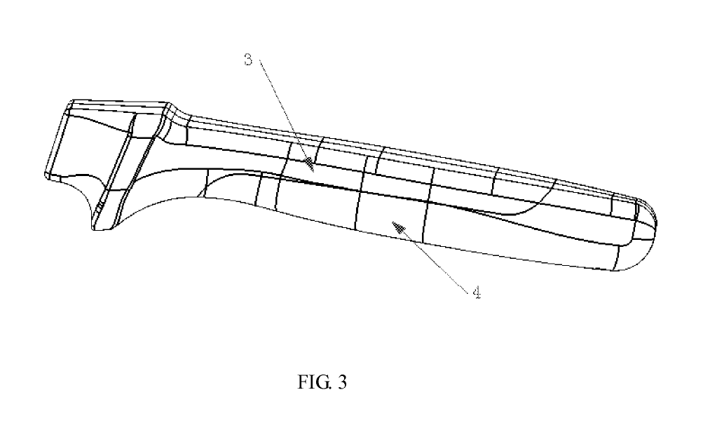

FIG. 1 depicts the tubular mask according to one embodiment of the present invention. The tubular mask 1 includes an accommodating space 11 for accommodating the hardware tool. The accommodating space has its periphery for contacting the hardware tool provided with a contacting surface 12. The contacting surface and the hardware tool 2 contact each other in a watertight manner. When the hardware tool is received in the tubular mask, as shown in FIG. 2, the contacting surface and the hardware tool contact each other tightly to the extent that water is prevented from existing therebetween. When the water transfer printing process is completed and the hardware tool is dry, with the tubular mask 1 removed, the hardware tool has the pattern 3 printed thereon, as shown in FIG. 3.

It is clear that the tubular mask 1 may have a structure designed to its intended use and different from that describe in the aforementioned embodiment.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for transfer printing a hardware tool, comprising steps of:
Step 1: selecting a transfer printing film according to a pattern to be printed on the hardware tool, and activating the transfer printing film;
Step 2: covering an area on the hardware tool out of the pattern using a tubular mask, placing the hardware tool together with the tubular mask into water, and using the activated transfer printing film to perform transfer printing; and
Step 3: removing the hardware tool and the tubular mask from the water, to baking or air-drying the hardware tool and the tubular mask to dry, and removing the tubular mask from the hardware tool.

2. The method of claim 1, wherein the tubular mask is made of a waterproof material.

3. The method of claim 1, wherein the tubular mask includes an accommodating space for accommodating the hardware tool, in which the accommodating space has its periphery for contacting the hardware tool provided with a contacting surface.

4. The method of claim 3, wherein the contacting surface and the hardware tool are configured to contact each other in a watertight manner.
